(19) United States
(12) Patent Application Publication
(10) Pub. No.: US 2020/0400175 A1
(43) Pub. Date: Dec. 24, 2020

(54) JOINING SYSTEM

(71) Applicant: Goodcart PTY LTD, Mona Vale (AU)

(72) Inventor: Douglas Rawson-Harris, Mona Vale (AU)

(21) Appl. No.: 16/975,102

(22) PCT Filed: Feb. 22, 2019
(86) PCT No.: PCT/AU2019/050147

§ 371 Date: Aug. 21, 2020

(30) Foreign Application Priority Data
Feb. 23, 2018 (AU) 2018900582

(51) Int. Cl. F16B 7/02; E04H 12/00

(52) U.S. Cl. CPC F16B 7/02; E04H 12/00

(57) ABSTRACT

A system for fixings and/or preventing relative movement between two elongated members particularly for a pole. The system comprises couplings provided by pairs of tapered bodies. The elongate mast portion is of a smaller cross-section than the base portion and can at least partially fit within the base portion. The respective tapered body providing engagement surfaces which upon entry of the mast into the base increase the area of mutual contact and increase the lateral force applied between the mast and the base thereby preventing or at least reducing relative movement therebetween.

### TECHNICAL FIELD

The present invention relates to mechanisms for securing tubes, elongate members, such as poles of differing cross-sectional sizes and shapes to each other and particularly but not only to adjustable pole support arrangements used in construction, e.g. street lighting poles or similar support structures, having a base and a mast held therein.

### BACKGROUND

Any discussion of the prior art throughout the specification should in no way be considered as an admission that such prior art is widely known or forms part of common general knowledge in the field.

In the field of elongated support structures and in particular street poles or lighting, there have been significant changes made in the manufacture and installment of such street and outdoor lighting poles.

Previously, support structures for street lighting etc. were constructed from timber or as a unitary steel tubular body. Architectural design and aesthetic demand has led to the development of a wide range of options for such street lighting.

With urban designers requiring the need for pole mounted lighting, traffic control, CCTV, banners, signage, public warning, communication, environmental monitoring, pedestrian management and many other applications in public areas it was inevitable that a streetscape would become cluttered with a myriad of different poles delivering these services. Not only has this become visually unsatisfactory in many places but also it has created a maze of obstructions in pedestrian areas using up valuable civic space.

This has a new generation of light poles that delivers to the community an effective solution to the growing number of single purpose poles that are sprouting in the urban environment.

In particular the applicant has developed its Multipole™ and Multipole Solar™ products that deliver an aesthetically pleasing all aluminium multi-function pole that can provide a flexible secure home for many of the services required in the streetscape. In addition the poles can be the basis for the provision of public amenities such as bike racks, bus shelters, water bubblers and seats.

Early generations of these poles relied on a steel core clad in aluminium decorative cladding however recent developments have removed any reliance on steel by designing a pole based on the applicant's own extrusion technology.

This provides a number of significant advantages including improves sustainability since aluminium poles have a smaller carbon footprint, reduce installation costs as the weight of aluminium poles is substantially less than steel poles and the composite arrangement of producing the pole in separate connectable tubes reduce transport costs, low maintenance costs and resistance to graffiti, a safer pole due to its inherent energy absorbing nature of aluminium as compared with steel, excellent strength and ability to withstand severe environmental conditions, aesthetic advantages since there are no welded joints in the extruded aluminium pole section (such welded joints also provide a weakness in conventional steel poles) as well as the ability to produce tracks or channels in the aluminium extrusion to allow installation of accessories at various heights over the pole.

In one particular embodiment, the poles may be made from a series of connectable or extrusion tubes, e.g. at least two. Generally the lower larger cross-section tube acts as a base and is embedded or connected to the substrate or foundation with a small tube or “mast” nesting therein. The smaller or upper tube may then be raised to the desired height. Generally a permanent fixing arrangement is provided by means of bolts, fasteners or similar extending through the outer edge of the base tube into the mast to ensure they are held in the appropriate “final” position. However, such an arrangement is expensive and timely to install. Drilling of holes, insertion of appropriate fasteners etc. is difficult.

In addition, as mentioned above, the aesthetics of street lighting and other support poles has become an important design criteria. Many recent designs will have their aesthetic value diminished by an unsightly connection arrangement between the upper and lower poles.

It is an object of the present invention to overcome or ameliorate at least one of the disadvantages of the prior art, or to provide a useful alternative.

### DISCLOSURE OF THE INVENTION

In a first broad aspect, the present invention provides a system for fixing and/or preventing relative movement between two elongated members, a first member having a first cross-section, and a second member having a second cross-section smaller than the first cross-section such that the second member may be at least partially recessed within the first member, said system comprising at least one coupling extending between the first and second members, each coupling comprising at least a pair of tapered bodies adapted to extend in complementary fashion from each of the first and second members to provide respective engagement surfaces extending between a leading portion and a trailing portion of each said tapered body, each said body being tapered from their trailing portion to their leading portion and aligned to contact respective engagement surfaces upon entry of the second member into the first member whereby as the engagement surfaces increase the area of mutual contact, increasing lateral force is applied between the first and second members.

Unless the context clearly requires otherwise, throughout the description and the claims, the words “comprise”, “comprising”, and the like are to be construed in an inclusive sense as opposed to an exclusive or exhaustive sense; that is to say, in the sense of “including, but not limited to”.

In a preferred embodiment at least a pair of couplings are provided between the first and second members.

In another embodiment at least four couplings are preferably provided in opposing pairs are provided between the first and second members.

Preferably each coupling, in use, is freely held between the first and second members with no need for fixing of the tapered bodies to either of the first or second members.

The term “freely held” refers to the fact that the first and second members are held and maintained in position by the compressive forces and/or friction therebetween. In other words once such compressive forces and/or friction is released, the various components are free to be uncoupled.

Alternatively, in another embodiment one of the first or second tapered bodies is fixed to a respective first or second member, by chemical and/or mechanical means.

The engagement surfaces are preferably configured to slidably engage on contact. Preferably the force applied to disengage the engagement surfaces of the respective tapered bodies is greater than the force required to engage said engagement surfaces.

The coupling and tapered bodies are preferably adapted to extend primarily in the axial direction.

Preferably either the first or second members are provided with internal or external channels adapted to slidably receive one or more tapered bodies of each coupling.

Preferably the members are elongated tubes or rods. In a particular embodiment, the first member is a tube and the second member is a rod or tube which fits at least partially within the first tube. While the specification may refer to tubes, it will be understood that at least the second member can also be solid in cross-section.

The inventive system provides a reliable and cost-effective mechanism of mounting the second member within the first member and preventing relative movement therebetween. The couplings are preferably spaced at regular intervals around the gap between the second member and the first member. As mentioned above, the tapered bodies are positioned to extend preferably axially. A first tapered body can be provided on the interior surface of the larger or base tube. The second tapered body can be provided on the exterior of the second member. These tapered bodies are aligned and adapted to provide mutually engageable surfaces as the second member is inserted within the first member. This results in a lateral force being applied between the first and second members as a result of “expansion” of the resultant couplings.

To explain, the coupling is provided by two tapered bodies which extend in complementary fashion. At its narrowest width i.e. with the narrow tapered leading portions contacting, the coupling will have a width narrower than the gap between the first and second members such that it can be fitted in between this gap. As the area of mutual contact increases i.e. as the leading portion of each tapered body moves towards the trailing portion of the opposite tapered body, the width of the coupling expands. In one embodiment this increase in width is around 3 mm. It is this increase in width which produces the lateral force between the first and second tubes/rods and thereby mounts the second member within the first member and prevents relative movement therebetween.

In a particularly preferred embodiment, the system can allow limited elastic deformation of the various components when installed. For instance, the first member can elastically, or resiliently deform upon “expansion” of the couplings to a non-circular shape. For instance, if two couplings are used, say on opposite sides, the first member may deform to an oval shape. If four couplings were used, the first member may deform to a shape approaching a “rounded square”. Similarly, the second member may compress upon engagement of the couplings in a similar fashion.

Alternatively, the couplings themselves may elastically, or resiliently deform. As will be discussed below, the tapered bodies themselves can be resiliently deformable. In such an instance it is preferred that the engagement surfaces are relatively rigid to ensure reliable engagement. A base or footing can extend from the engagement surfaces. This base or footings can resiliently deform in response to the compressive lateral force. This provides a “spring loaded” nature of the coupling in the lateral direction. A person skilled in the art will understand that such resilient deformation can manifest in any one or more of the first member, second member or coupling.

In use, there is no need for bolting, screwing or gluing of the various components, although it may assist in aligning and contacting the engagement surfaces of the tapered bodies to form the coupling.

Preferably, the engagement surfaces of the first and second members are configured or modified to have a directional surface. In other word when installed, the force needed to disengage the tapered bodies is substantially greater than the force required to initially engage the bodies. This can be achieved by providing a non-symmetrical sawtooth type structure.

There are a number of significant advantages provided by the aforementioned systems. The speed and reliability associated with the mounting system. There are also benefits in terms of aesthetics with no unsightly welding, screws, bolts etc. It is possible in one embodiment to release the coupling and thereby alter the relative positioning of the second member within the first member. This is particularly useful where the first tube is a base with the second tube being a mast or pole extending therefrom. The inventive coupling allows adjustment or repositioning of the mast/pole within the base. This allows more flexible use of the mast within the base and is particularly useful in cases where the pole has multiple uses e.g. street lighting, advertising etc.

Additionally, the coupling and tapered bodies can extend between elongated members of similar cross sectional shapes or different cross sectional shapes. As it will be clear to a person skilled in the art, the couplings can be designed to “compensate” for differences in cross sectional shape. In conventional systems, fixing a circular mast to a square base for instance can be difficult. With the present invention, on the other hand, suitably configured couplings can compensate for differences between the two shapes.

In a second broad aspect, the present invention provides a method for fixing and/or preventing relative movement between two elongate members, a first elongated member having a first cross-section, and a second elongated member having a second cross-section smaller than the first cross-section such that the second member may be at least partially recessed within the first member, said method comprising providing at least one coupling extending between the first and second members, each coupling comprising at least a pair of tapered bodies adapted to extend in complementary fashion from each of the first and second members to provide respective engagement surfaces extending between a leading portion and a trailing portion of each said tapered body, each said body being tapered from their trailing portion to their leading portion, said method further comprising aligning respective engagement surfaces and inserting said second member into said first member to increase the area of mutual contact of the engagement surfaces and thereby apply sufficient lateral force between the first and second members to reduce and/or prevent relative movement therebetween.

In a third broad aspect, the present invention provides a pole comprising at least an elongated base member having a first cross-section, and an elongated mast member having a second cross-section smaller than the first cross-section such that the mast may be at least partially recessed within the base member, said pole further comprising at least one coupling extending between the mast member and the base member, each coupling comprising of at least a pair of tapered bodies adapted to extend in complimentary fashion from each of the base and mast members to provide respective engagement services extending between a leading portion and a trailing portion of each said tapered body, each said body being tapered from their trailing portion to their leading portion and aligned contact with respective engagement services upon entry of the mast member into the based whereby the engagement services increase the area of mutual contact, increasing lateral forces applied between the mast and base members.

### BRIEF DESCRIPTION OF THE DRAWINGS

The present invention will now be described with reference to the accompanying drawings in which;

FIG. 1 is a perspective view of a tapered body in accordance with a first embodiment of the present invention.

FIGS. 2 and 3 are cross-sectional views of a coupling comprising a pair of tapered bodies in a partially engaged and fully engaged configurations respectively in accordance with another embodiment of the present invention.

FIG. 4 is a cross-sectional view of a pole having a first and second tube with a plurality of couplings extending therebetween.

FIGS. 5 and 6 are cross-sectional and perspective views of a first and second elongated members partially engaged and held by a coupling in accordance with the preferred embodiment of the present invention.

FIGS. 7 and 8 are cross-sectional and perspective views of a first and second elongated members in a fully engaged configuration in accordance with yet another embodiment of the present invention.

### BEST MODE(S) FOR CARRYING OUT THE INVENTION

The present invention seeks to provide a reliable cost effective aesthetically pleasing system and method of connecting and preventing movement between first and second members adapted to fit within one another. In a particularly preferred embodiment, the present invention is useful for connecting the mast and base of a two piece pole such as a lighting pole. The present invention will be now described with reference to such a mast/base embodiment but it will be understood by persons skilled in the art that this terminology is in no way limiting in regard to the use and functionality of the present invention.

In particular it should be noted that in the field of telegraph poles, masts etc the forces applied to the various components by weight, wind, supported devices such as lights, advertising, mobile telephone stations, etc is quite considerable. Further, the aforementioned system provides for a mast or pole to be produced from multiple components and constructed on site rather than being formed as a unitary body or requiring complex welding of multiple components. This of course has significant advantages over the prior art.

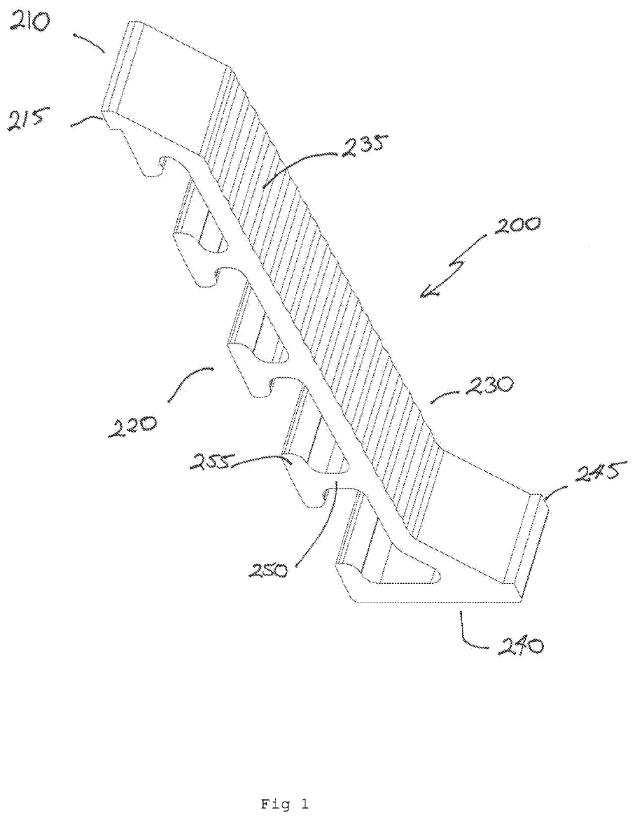

Turning firstly to FIG. 1, shown therein is a tapered body 200. The tapered body has a leading portion 210 and a trailing portion 240. A base portion 220 extends along one side of the tapered body 200 between the leading portion 210 and the trailing portion 240. On the opposite side from the base portion 220, engagement portion 230 extends between leading portion 210 and trailing portion 240. As will be discussed below, engagement portion 230 is provided with an engagement surface 235. A lip or flange 215, 245 may be provided on the respective leading portion 210 and trailing portion 240 as will be discussed below. The functionality and configuration of the engagement surface 235 is discussed below.

The base portion 220 can be formed as a continuous surface or as shown in FIG. 1 a series of legs 250 with foot portions 255 are arranged to define the base portion 220.

As shown in FIG. 1, the tapered body 200 tapers or reduces in depth between the trailing portion 240 and leading portion 210. In other words, the distance between the base portion 220 and engagement portion 230 increases along the length of the body 200 from the leading portion 210 to the trailing portion 240.

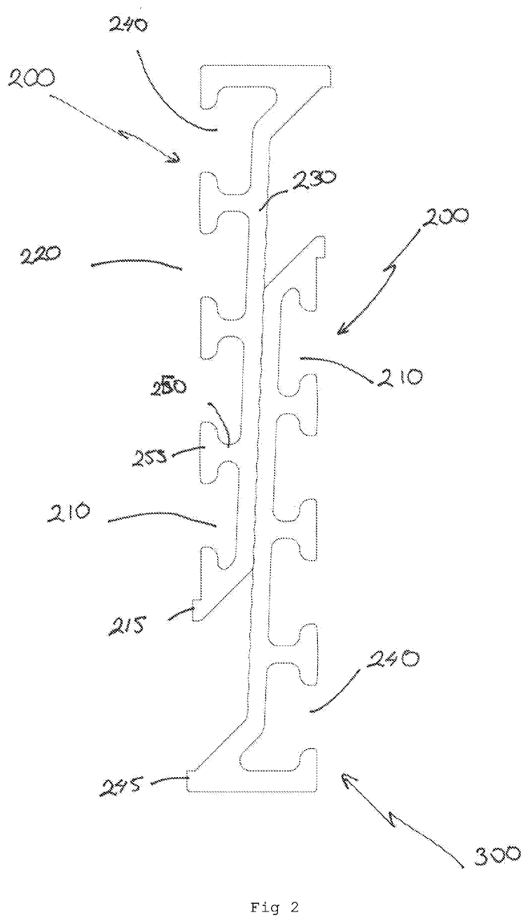

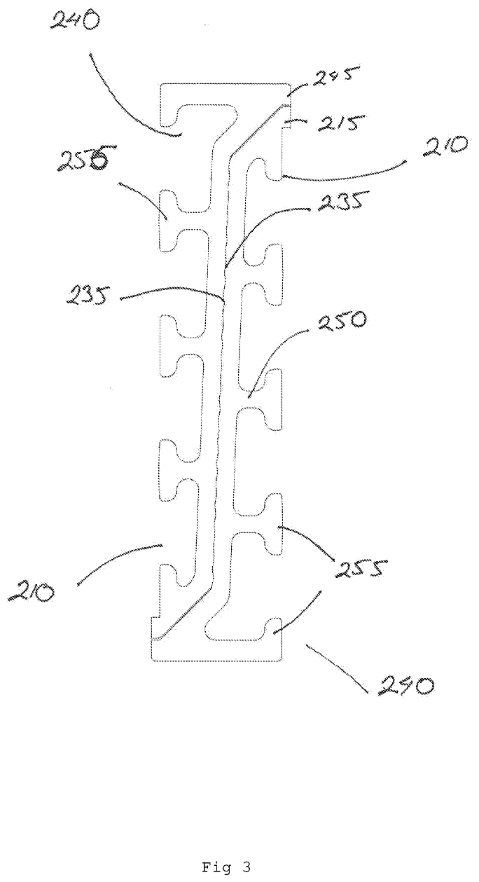

The tapered body 200 is adapted for engagement in a complementary fashion with an identical tapered body as shown in FIGS. 2 and 3 to form a coupling 300. In the embodiment shown in FIG. 2, the tapered bodies 200 are in partial engagement.

Engagement commences on contact of the respective leading portions 210 of the respective tapered bodies. In such an engagement, the respective engagement surfaces 235 are in mutual contact. Preferably the engagement surfaces are modified to increase their coefficient with friction thereby preventing disengagement of the respective engagement surfaces 235. In a particularly preferred embodiment, the engagement surfaces 235 are directionally modified such that the force needed to pass the engagement surfaces over each other during engagement is substantially less than disengagement in use.

As the tapered bodies 200 continue to engage ie, the leading portions 210 continue to move towards the trailing portion 240 of the opposite tapered body, they reach full engagement as shown in FIG. 3, where the leading portion 210 of one tapered body 200 is directly adjacent to the trailing portion 240 of the opposing tapered body 200.

As will be clear to the person skilled in the art, as the tapered bodies 200 move from partial engagement shown in FIG. 2 to full engagement shown in FIG. 3 the distance between the relative base portions 220 of both tapered bodies 200 will increase i.e. the width of the coupling 300 increases thereby applying an outward force as will be explained below.

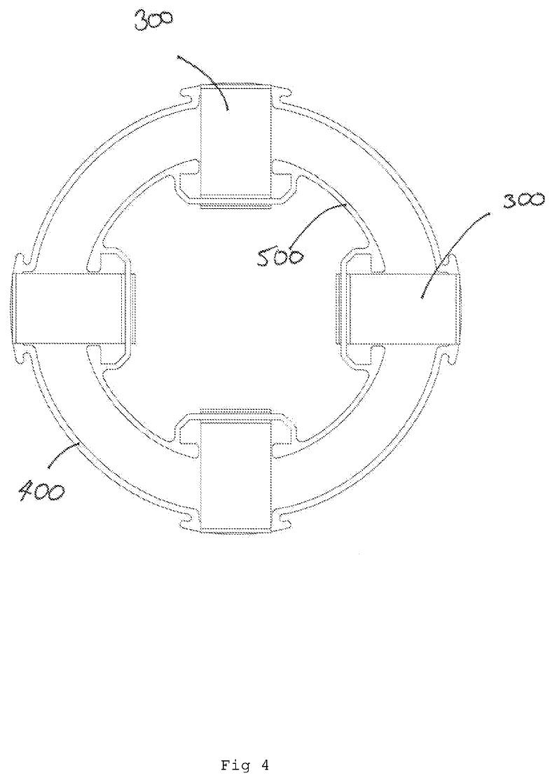

The aforementioned couplings 300 provided by the respective tapered bodies 200 are arranged to be positioned between, and prevent relative movement between a pair of elongate members for example a base and mast of a pole, the mast being at least partially received within the base. In this regard, reference is made to FIG. 4 which shows the cross section of a base tube 400 with a mast 500 at least partially received therein. Couplings 300 extend between the inner surface of the base 400 and outer surface of the mast 500. In this instance the coupling 300 are spaced at regular intervals around a gap 600 extending between the base 400 and mast 500.

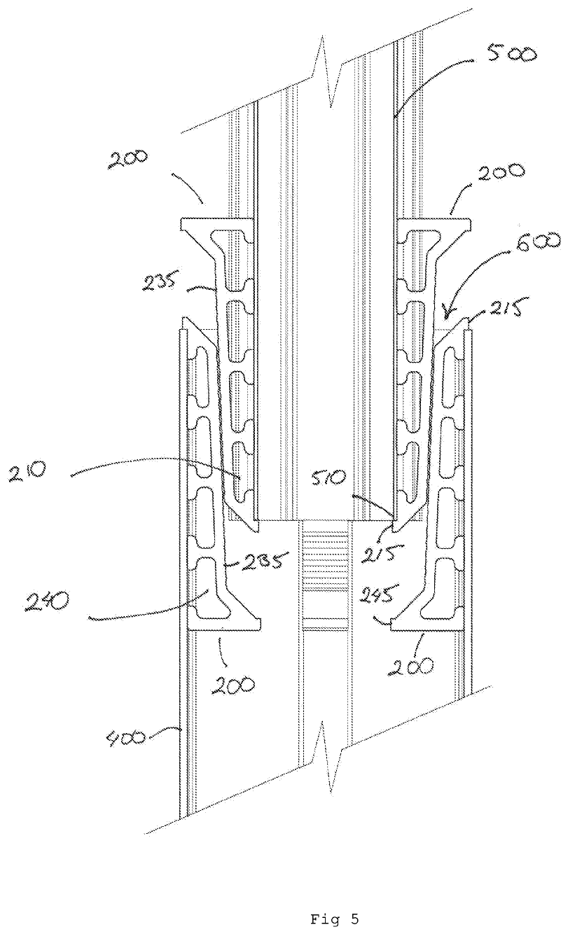

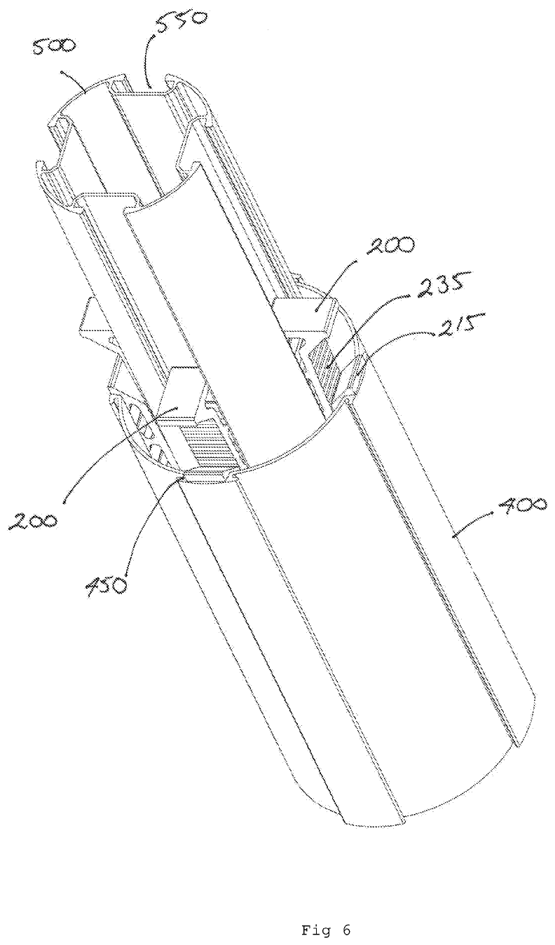

The installation and function of the aforementioned mounting system will be discussed with reference to FIGS. 5-8. In these figures, the mast 500 is partially inserted into the base 400 forming an annular gap 600 therebetween. The couplings 300 extend in an axial direction in a substantially mutual parallel array between the mast 500 and base 400. This partial insertion position is more clearly shown in FIGS. 5 and 6. As will be appreciated by a person skilled in the art, and as discussed above, in this initial engagement, the engagement surfaces 235 of the respective tapered body are only partially in contact.

In the embodiment of FIGS. 5 to 8, the base 400 has at least a pair of tapered bodies 200 extending from its upper rim 410 and preferably held in place by flange 215 at the tapered portion 210. The mast 500 of the pole is also provided with at least a pair of tapered bodies 200 which extends upwardly from its lower edge 510. Again the lip or flange 215 of the tapered portion contacts the leading edge or rim 510 of the mast 500. In this configuration, the mast 500 with tapered bodies 200 attached thereto is inserted into the upper end of the base to thereby engage the respective tapered bodies as discussed above.

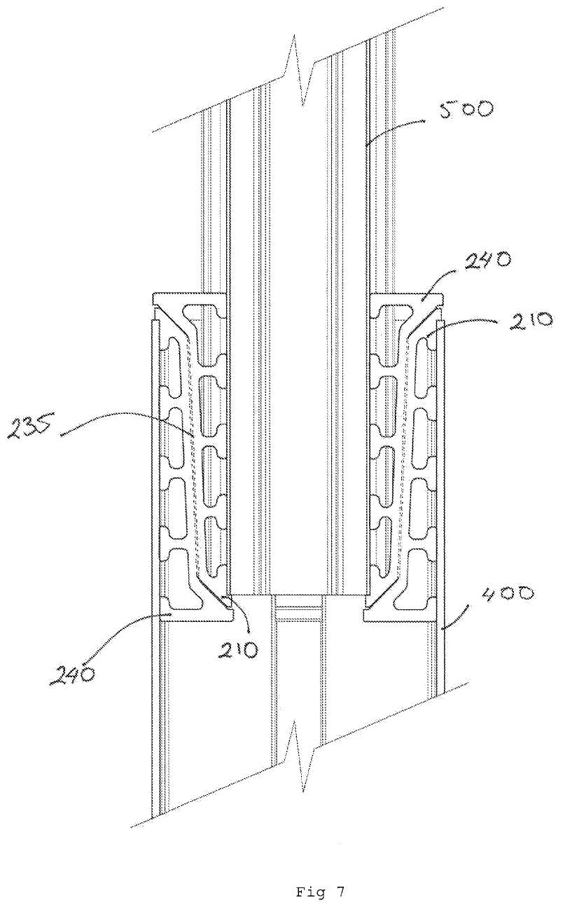

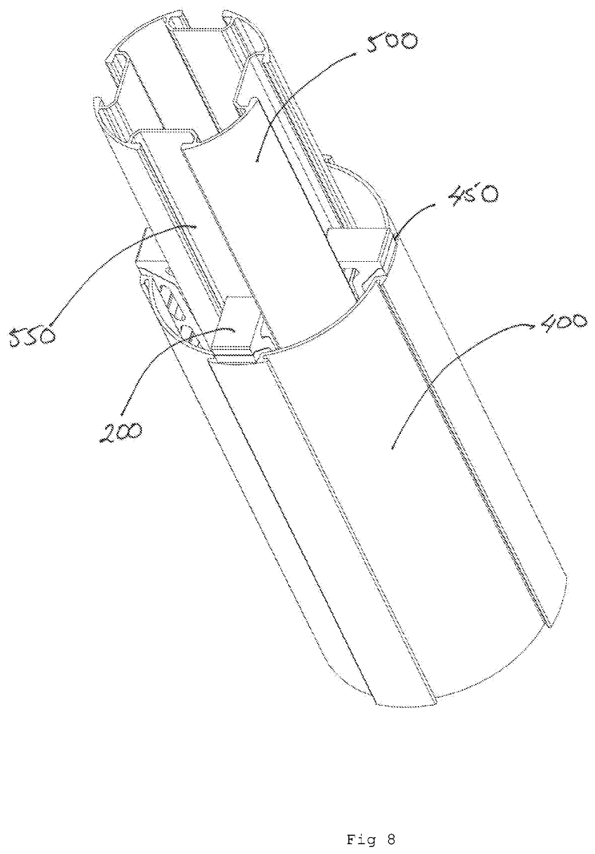

As the mast 500 is continued to be inserted into the base 400, the respective tapered bodies 200 continue to engage their respective engagement surfaces 235 (as discussed above) until they reach full engagement as shown in FIGS. 7 and 8. The engagement of flanges 215 with the leading edges of the mast and base, means that no additional force is necessarily required to insert/engage the tapered bodies 200. The tapered bodies 200 in the base 400 are prevented from moving as the mast enters by the engagement of the flange 215 with the leading edge 410 of the base portion 400. Similarly, as the mast 500 enters the base portion 400, it forces the tapered body 200 into engagement by means of the flange 215 engaging leading edge portion 510. The necessary force to connect the base 500 and mast 400 by engagement of the couplings 300, can be transmitted through the movement of the mast 500 into the base 400. If desired, additional force can be applied directly to the tapered body 200 but this is not absolutely necessary to provide such engagement. At the full engagement position shown in FIG. 7, respective leading portions 210 of the respective tapered body 200 are directly adjacent to trailing portion 240 of the opposing tapered body. In this position, the respect flanges 215 come into contact with and abut flanges 245.

In this full engagement position, equal and opposite lateral forces are applied by the coupling 300 to the inner tube or mast 500 and outer tube or base 400 such that the tubes are locked together or at the very least relative movement therebetween is extremely difficult.

This equal and opposite lateral force is applied preferably at regular intervals around the mast 500 and base 400. Engagement surface are provided with a friction modified surface such as “saw tooth” surface as shown in FIGS. 1-3. In a particularly preferred embodiment, the engagement surfaces are directionally modified e.g. an asymmetric saw tooth, such that disengagement requires considerably greater force. In order words, the initial engagement of the engagement surfaces 235 in quite straight forward and requires relevantly low force. However, in the full engagement position wherein the coupling is held by the compressive forces between the first and second tubes, this engagement of the tapered bodies 200 requires substantially greater force. The couplings are dimensioned such that the widening or “expansion” of the couplings applies the aforementioned lateral forces, but does not weaken or in any way damage the base 400 or mast 500.

In one particular embodiment, the mast and base are preferably circular in cross-section. At least the engagement surfaces 235 of the respective tapered body are however preferably configured to prevent relative rotation of the mast 500 and base 400. In the embodiment shown the engagement surfaces 235 are substantially planar. This multiple engagement of planar surfaces around the annular gap 600 between the mast 500 and base 400 prevents relative rotation therebetween. This rotation prevention could also be provided by a groove and flange on the engagement surface of the tapered bodies adapted to permit the aforementioned slidable engagement in the axial direction but prevent relative rotation therebetween.

As shown more clearly in the embodiment of FIGS. 4, 6 and 8, recesses 550, 450 may also be provided in the mast 500 and/or base 400 opening into the annular gap 600 therebetween for positioning and aligning the aforementioned tapered bodies/couplings. As shown more clearing in FIG. 4, the larger diameter base portion 400 can include internal recesses 450 for positioning of the aforementioned respective tapered body 200. Similarly, the smaller diameter mast section 500 may include external recesses 550 for positioning of its respective tapered body 200. Upon engagement of the respective tapered bodies to form the desired couplings, it can be seen that relative rotation between the mast and base is prevented by interference between the coupling 300, formed by the engaged tapered bodies 200, and the aforementioned recesses 450, 550.

In the embodiments shown, both the outer tube/base and inner tube/mast are substantially circular and hollow in cross-section. It will be understood by persons skilled in the art, however, the aforementioned arrangement can be provided in other configurations e.g. square, oval etc. cross sections as well as solid tubes. It will also be understood that the outer and inner tubes can be of different shapes. In this regard, the couplings 300 may be designed to compensate between these shapes. For instance, a square base may be provided with couplings in each corner extending to a circular in a tube.

In other embodiments, the system can be arranged to allow deformation of the various components to assist in reliable connection between the two elongate members. For instance, either of the elongate members can be arranged to resiliently deform in response to installation of the coupling and the resultant lateral forces. Particularly, the larger or first tube, e.g. base 400 can be arranged to deform in response to the internal force applied by the couplings. If the base 400 is circular in cross-section, and for instance two couplings 300 were used, the cross-section may deform to an oval type shape. Preferably this deformation is resilient and the mast would return to its original cross-section when the couplings are removed. If, four couplings were required between the base 400 and mast 500, the base 400 may deform into a “rounded square” type cross-section.

Similarly, the mast 500 could deform in response to the compressive forces applied by the couplings.

In an alternative embodiment, the tapered bodies themselves can be arranged to be resiliently deformable. In one embodiment, the legs/feet 250/255 of the tapered bodies can be designed to be resiliently compressible/deformable. There are a variety of configurations which could be provided in this regard. In one embodiment the legs may be formed similar to “leaf springs” such that they resiliently deform under compressive force. Other arrangements to provide a resiliently deformable coupling 300 or tapered body 200 would be known to those skilled in the art. But it is preferred that at least the engagement surfaces 235 bodies 200 are substantially incompressible.

Preferably, the tapered bodies are arranged to be held by the compressive force between the mast 500 and base 400. In some embodiments, the tapered bodies can be fixed to the mast and pole respectively by any suitable means, e.g. glueing. In such an arrangement, one tapered body would be fixed to the first member, or the second tapered body fixed to the second member for easy engagement between the two members. It is important to recognise that the connection between the first and second members, however, is via the engagement surfaces 235 provided by the tapered bodies 200/couplings 300.

If desired, a cover can be provided to close the gap between the mast and base following full engagement thereof.

The inventive system holds the mast and base primarily with strong compressive frictional forces alone. Accordingly, and as discussed above if necessary they can be uncoupled without damaging the various components.

The present invention provides a reliable, safe rapid and aesthetically pleasing system of fixing the first tube/mast to its second tube/base. Previous systems involved permanent fixtures such as screws or welding etc. These can be unsightly and unreliable, or prone to unauthorised removal. As will be appreciated by a person skilled in the art, the stresses applied to the connection can be quite high. The contact surface between the mast and base in conventional systems is reduced as compared with the present inventive system and in some cases can fail under stress. The present inventive system provides a much greater engagement surface between the first tube/mast and second tube/base.

The present inventive fixture system is particularly suitable for aluminium pole. As will be clear to persons skilled in the art, welding of aluminium is specialised and expensive process. The present system utilizes preferably aluminium component which are held in place by frictional/compressive forces between the two tubes. The system is therefore substantially quicker and more reliable in service than conventional systems of welding or fixture by screw etc.

1. A system for fixing and/or preventing relative movement between two elongate members, a first elongated member having a first cross-section, and a second elongated member having a second cross-section smaller than the first cross-section such that the second member may be at least partially recessed within the first member, said system comprising:
at least one coupling extending between the first and second members, each coupling comprising at least a pair of tapered bodies adapted to extend in complementary fashion from each of the first and second members to provide respective engagement surfaces extending between a leading portion and a trailing portion of each said tapered body, each said body being tapered from their trailing portion to their leading portion and aligned to contact respective engagement surfaces upon entry of the second member into the first member whereby as the engagement surfaces increase the area of mutual contact, increasing lateral force is applied between the first and second members wherein at least a pair of couplings are provided between the first and second members.

2. (canceled)

3. A system as claimed in claim 1, wherein at least four couplings are provided in opposing pairs between the first and second members.

4. A system as claimed in claim 1, wherein each coupling, is freely held between the first and second members by frictional and/or compressive force.

5. A system as claimed in claim 1, wherein at least one of the first or second tapered bodies is chemically and/or mechanically fixed to a respective first or second member.

6. A system as claimed in claim 1, wherein engagement surfaces are configured to slidably engage on contact.

7. A system as claimed in claim 1, wherein the engagement surfaces are directionally modified such that in use, a force required to slidably disengage the engagement surfaces of the respective tapered bodies is greater than the force required to engage said engagement surfaces.

8. A system as claimed in claim 1, wherein the couplings are adapted to extend primarily in the axial direction.

9. A system as claimed in claim 1, wherein the first and/or second members are provided with internal or external channels adapted to slidably receive and retain one or more tapered bodies of each coupling.

10. A system as claimed in claim 1, wherein at least one of the elongate members or tapered bodies are resiliently deformable in use.

11. A method for fixing and/or preventing relative movement between two elongate members, a first elongated member having a first cross-section, and a second elongated member having a second cross-section smaller than the first cross-section such that the second member may be at least partially recessed within the first member, said method comprising:
providing at least one coupling extending between the first and second members, each coupling comprising at least a pair of tapered bodies adapted to extend in complementary fashion from each of the first and second members to provide respective engagement surfaces extending between a leading portion and a trailing portion of each said tapered body, each said body being tapered from their trailing portion to their leading portion, and
aligning respective engagement surfaces and inserting said second member into said first member to increase the area of mutual contact of the engagement surfaces and thereby apply sufficient lateral force between the first and second members to reduce and/or prevent relative movement therebetween, wherein at least a pair of couplings are provided between the first and second members.

12. (canceled)

13. A method as claimed in claim 11, wherein at least four couplings are provided in opposing pairs between the first and second members.

14. A method as claimed in claim 11 wherein each coupling, is freely held between the first and second members by frictional and/or compressive force.

15. A method as claimed in claim 11, wherein at least one of the first or second tapered bodies is chemically and/or mechanically fixed to a respective first or second member.

16. A method as claimed in claim 11, wherein said engagement services are slidably engaged on contact.

17. A method as claimed in claim 11, wherein the engagement surfaces are directionally modified such that in use, a force required to slidably disengage the engagement surfaces of the respective tapered bodies is greater than the force required to engage said engagement surfaces.

18. A method as claimed in claim 11, wherein said couplings are provided in a substantial axial direction.

19. A method as claimed in claim 11, wherein the first and/or second members are provided with internal or external channels adapted to slidably receive and retain one or more tapered bodies of each coupling.

20. A method as claimed in claim 11, wherein at least one of the elongate members or tapered bodies are resiliently deformable in use.

21. A pole comprising:
at least an elongated base member having a first cross-section, and an elongated mast member having a second cross-section smaller than the first cross-section such that the mast may be at least partially recessed within the base member, and
at least one coupling extending between the mast member and the base member, each coupling comprising of at least a pair of tapered bodies adapted to extend in complimentary fashion from each of the base and mast members to provide respective engagement surfaces extending between a leading portion and a trailing portion of each said tapered body, each said body being tapered from their trailing portion to their leading portion and aligned to contact with respective engagement surfaces upon entry of the mast member into the based whereby the engagement surfaces increase the area of mutual contact, increasing lateral forces applied between the mast and base members, wherein at least a pair of couplings are provided between the base and mast members.

22. (canceled)

23. A pole as claimed in claim 21, wherein at least four couplings are provided in opposing pairs between the base and mast members.

24. A pole as claimed in claim 21, wherein each coupling, is freely held between the base and mast members by frictional and/or compressive force.

25. A pole as claimed in claim 21, wherein at least one of the first or second tapered bodies is chemically and/or mechanically fixed to a respective base or mast member.

26. A pole as claimed in claim 21, wherein engagement surfaces are configured to slidably engage on contact.

27. A pole as claimed in claim 21, wherein the engagement surfaces are directionally modified such that in use, a force required to slidably disengage the engagement surfaces of the respective tapered bodies is greater than the force required to engage said engagement surfaces.

28. A pole as claimed in claim 21, wherein the couplings are adapted to extend primarily in the axial direction.

29. A pole as claimed in claim 21, wherein the base and/or mast members are provided with internal or external channels adapted to slidably receive and retain one or more tapered bodies of each coupling.

30. A pole as claimed in claim 21, wherein at least one of the base or mast members or tapered bodies are resiliently deformable in use.
